(19) United States
(12) Patent Application Publication
(10) Pub. No.: US 2006/0184634 A1
(43) Pub. Date: Aug. 17, 2006

(54) ELECTRONIC MAIL SYSTEM USING EMAIL TICKLER

(75) Inventors: Brad Owen, Mesa, AZ (US); Jason Steiner, Glendale, AZ (US)

Correspondence Address: GO DADDY GROUP, INC., 14455 NORTH HAYDEN ROAD, SUITE 219, SCOTTSDALE, AZ, 85260, US

(73) Assignee: THE GO DADDY GROUP, INC., Scottsdale, AZ (US)

(21) Appl. No.: 11/419,160

(22) Filed: May 18, 2006

(51) Int. Cl. G06F 15/16

(52) U.S. Cl. 709/206

(57) ABSTRACT

Systems and methods of the present invention allow a Sender of an email message to save the message into a network email storage and send an Email Tickler to a Recipient. The Email Tickler contains a location reference for the email message at the network email storage. A Recipient's Receiving Means may download the email message from the network email storage. The Recipient's Receiving Means may further refuse downloading the email message if it determines that the network email storage location is not trustworthy. Systems and methods of the present invention may help in combating SPAM.

### CROSS REFERENCE TO RELATED PATENT APPLICATION

This patent application is related to U.S. patent application Ser. No. ______, “ELECTRONIC MAIL METHOD USING EMAIL TICKLER” concurrently filed herewith and also assigned to The Go Daddy Group, Inc.

### FIELD OF THE INVENTION

The present invention relates in general to electronic mail systems and methods and in particular to systems and methods for selective delivery of email messages, email security, anti-spam, and email delivery confirmation.

### BACKGROUND OF THE INVENTION

Users of computer networks, such as corporate networks or the Internet, routinely send electronic messages to each other. Electronic messages may contain, for example, text, images, links, and attachments. Electronic mail or email is one of the most widely used methods of communication over the Internet due to the variety of data that may be transmitted, the large number of available recipients, speed, low cost, and convenience.

Email messages may be sent, for example, between friends, family members, or between coworkers thereby substituting for traditional letters and office correspondences. This is made possible because the Internet has very few restrictions on who may send emails, the number of emails that may be transmitted and who may receive the emails. The only real hurdle for sending emails is the requirement that the sender must know the email address (also called network mailbox) of the intended recipient.

Email messages travel across the Internet, typically passing from server to server, at amazing speeds achievable only by electronic data. The Internet provides the ability to send an email anywhere in the world, often in less than a few seconds. Delivery times are continually being reduced as the Internet's ability to transfer electronic data improves.

Most Internet users find emails to be much more convenient than traditional mail. Traditional mail requires stamps and envelopes to be purchased and a supply maintained, while emails do not require the costs and burden of maintaining a supply of associated products. Emails may also be sent with the click of a few buttons, while letters typically need to be transported to a physical location, such as a mail box, before being sent.

Once a computer and a network connection have been obtained, there are typically few additional costs associated with sending emails. This remains true even if millions, or more, of emails are sent by the same user. Emails thus have the extraordinary power of allowing a single user to send one or more messages to a very large number of people at an extremely low cost.

The Internet has become a very valuable tool for business and personal communications, information sharing, commerce, etc. However, some individuals have abused the Internet. Among such abuses are spam and phishing. Spam, or unsolicited email, is the flooding of the Internet with many copies of the identical or nearly identical message, thereby forcing the message on people who might not otherwise choose to receive it. Most spam is commercial advertising, often for dubious products, get-rich-quick schemes, or financial or quasi-legal services.

A single spam message received by a user uses only a small amount of the user's email account's allotted disk space, requires relatively little time to delete and does little to obscure the messages desired by the user. Even a small number of spam messages, while still annoying, would nonetheless cause relatively few real problems. However, the amount of spam transmitted over the Internet is growing at an alarming rate. While a single or small number of spam messages are annoying, a large number of spam can fill a user's email account's allotted disk space thereby preventing the receipt of desired email. Also, a large number of spam can take a significant amount of time to delete and can even obscure the presence of desired emails in the user's email account.

Spam messages currently comprise such a large portion of Internet communications that they actually cause data transmission problems for the Internet as a whole. Spam creates data log jams thereby slowing the delivery of more desired data through the Internet. The larger volume of data created by spam also requires Internet providers to buy larger and more powerful (i.e. more expensive) equipment to handle the additional data flow caused by the spam.

Spam has a very poor response rate compared to other forms of advertisement. However, since almost all of the costs/problems for transmitting and receiving spam are absorbed by the recipient of the spam and the providers of the Internet infrastructure, spam nevertheless continues to be commercially viable for spammers.

Phishing is the luring of sensitive information, such as passwords, credit card numbers, bank accounts and other personal information, from an Internet user by masquerading as someone trustworthy with a legitimate need for such information. Often phishing goes hand-in-hand with spam. The perpetrators send out a large number of email messages to lure as many people as they can to their phishing “nets”. Typically, if a user clicks on a link in the email, it takes the user to a webpage that appears very similar to a business that the user might trust. However, this webpage is controlled by the perpetrators and any information entered on the webpage will be forwarded to the perpetrators. The perpetrators may use the users' information to commit fraud or other crimes. Often users' information is used for identity theft crimes.

If the user is able to see the URL address of the phishing webpage, the user may realize that it does not belong to a business that the user trusts. Phishers use various techniques to disguise their URL addresses. Among such techniques is hiding the true URL address in the phishing email behind some text, an address of a reputable business, or an image; removing the address bar in the Internet browser; replacing the address bar of the Internet browser with a fake address bar; using IP (Internet Protocol) numbers instead of a domain name in the URL; using domain names that are similar in spelling to the domain names of the reputable businesses; using extremely long URL addresses that the beginning of the address would not be plainly visible in the address bar of the Internet browser; etc. Also, long URL addresses may be harder to analyze, thus further helping the perpetrators in obscuring the true location of their phishing webpages.

There are various techniques used for combating spam and phishing. Among them are spam filtering, email challenge-response systems, maintaining white and/or black lists for email addresses, domain names, and IP numbers, Internet browser add-ons that show the true location of the pages viewed by the user, etc.

For many email filtering systems to work properly, the Sender's email address or at least its domain name part should be correct. Often malicious users forge (spoof) the Sender's email address when they send out spam, viruses, or phishing email messages.

Even though multiple systems are being used, the amount of spam, phishing, and other Internet abuses is steadily rising. The existing systems identify the trust level of the email senders or analyze the content of the email messages. However, an email sender may forge its true identity, use a temporary email account, use an open relay IP to send email messages, or use somebody else's computer to send messages if virus or spy software was installed (so called “zombie” computer). Also senders of spam and phishing attacks may provide email message content that is not related to the content of the links embedded in the email or they may use content that looks absolutely legitimate. All of these make it very hard to keep track of email addresses and originating IP addresses, as well as filtering messages based on their content.

Therefore, new systems and methods are needed to overcome the limitations of the current systems and methods. It is desired to create systems and methods that provide more efficient solutions for combating Internet abuses, such as spam and phishing.

### BRIEF DESCRIPTION OF THE DRAWINGS

FIG. 1 is a block diagram illustrating a prior art system for sending an email with a browser-executable link.

FIG. 2 is a block diagram illustrating a prior art email system with a Notification Agent.

FIGS. 3-6 are block diagrams illustrating sample embodiments of the systems of the present invention.

FIGS. 7-15 are flowcharts illustrating sample embodiments of the methods of the present invention.

### DETAILED DESCRIPTION AND PREFERRED EMBODIMENT

The present invention will now be discussed in detail with regard to the attached drawing figures which were briefly described above. In the following description, numerous specific details are set forth illustrating the Applicant's best mode for practicing the invention and enabling one of ordinary skill in the art of making and using the invention. It will be obvious, however, to one skilled in the art that the present invention may be practiced without many of these specific details. In other instances, well-known machines and method steps have not been described in particular detail in order to avoid unnecessarily obscuring the present invention. Unless otherwise indicated, like parts and method steps are referred to with like reference numerals.

Conventional electronic mail systems are push systems on the server level in the sense that the Sender's Client Software or the Sender's Email Server is “pushing” the email message to the Recipient's Email Server. Thus, the email message is typically “forced” on the Recipient. It should be noted that the Recipient's Client Software is typically “pulling” the messages from the Recipient's Email Server.

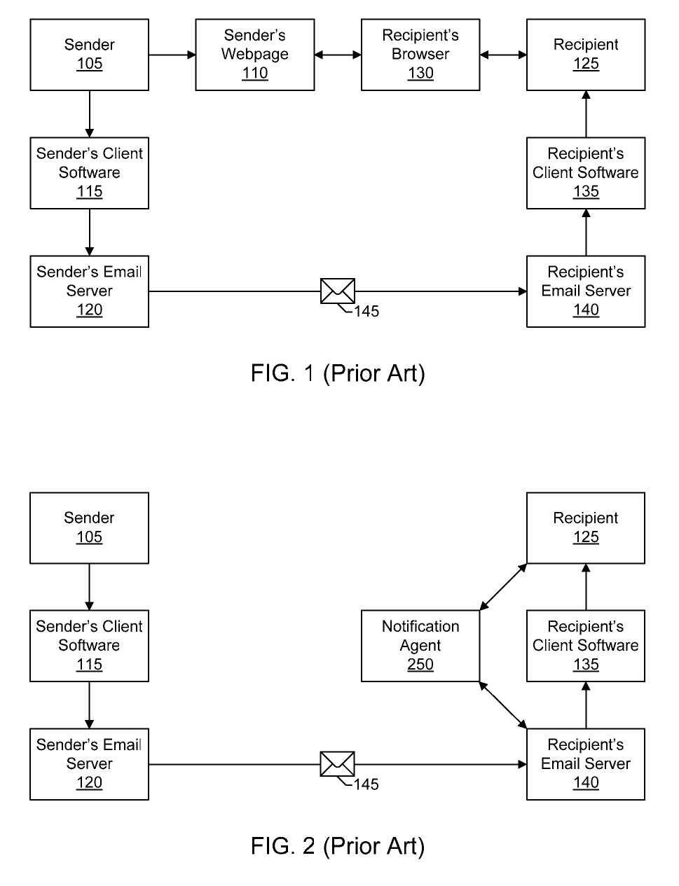

The prior art systems may emulate pull techniques by sending email messages with browser-executable links to webpages with additional information. Referring to FIG. 1, for example, a Sender 105 may send an Email Message 145 to a Recipient 125. The Sender 105 would typically use a Sender's Client Software 115 to form and forward the Email Message 145 to a Sender's Email Server 120. The Sender's Email Server 120, in turn, would send the Email Message 145 to a Recipient's Email Server 140. Further, the Recipient 125 may use a Recipient's Client Software 135 to download the Email Message 145 from the Recipient's Email Server 140.

Assuming that the Email Message 145 contains a browser-executable link, the Recipient 125 may click such link to open a Sender's Webpage 110 in a Recipient's Browser 130. The prior art systems may also utilize embedded/linked images, shared email attachments, and frames linked to a webpage to emulate pull techniques. If the embedded/linked images are used, the images are downloaded when the Recipient 125 opens the Email Message 145 using the Recipient's Client Software 135. The shared email attachments are downloaded when the Recipient 125 opens the attachment to the Email Message 145 using the Recipient's Client Software 135.

Referring to FIG. 2, the prior art email systems typically utilize a Recipient's Client Software 135 to pull Email Messages 145 from a Recipient's Email Server 140. Alternatively, a Notification Agent 250 may be running on the client's communication device (e.g. personal computer) that checks for the presence of new Email Messages 145 on the Recipient's Email Server 140. If the new Email Messages 145 are present on the Recipient's Email Server 140, the Recipient's Client Software 135 may download the Email Messages 145 to the Recipient's communication device or the Recipient 125 may otherwise view the messages, e.g. via an Internet browser.

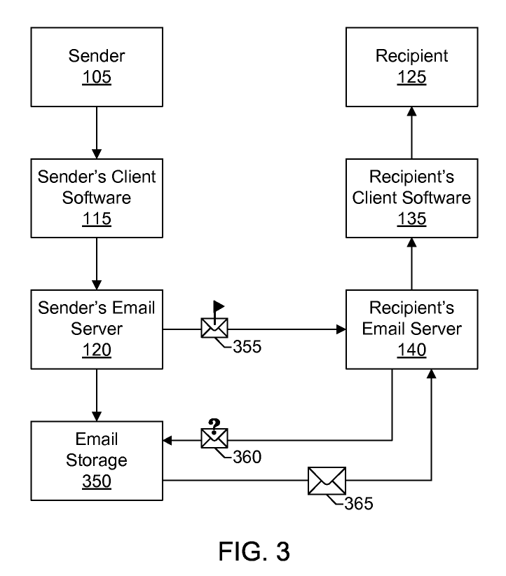

Referring to FIG. 3, an exemplary embodiment of the system of the present invention may include a Sender 105 that sends one or more Email Messages 365 to a Recipient 125. The Sender 105 and the Recipient 125 may be humans or automated means for sending and/or receiving the Email Messages 365. The Sender 105 may utilize a Sender's Client Software 115 to form and send the Email Messages 365. The Sender's Client Software 115 may include email client software, such as MS Outlook®, MS Outlook Express®, Eudora™ by QUALCOMM Incorporated, Thunderbird by Mozilla Corporation, Netscape Mail® by Netscape Communications Corp., Opera by Opera Software ASA, Lotus Notes® by IBM Corp., or any other communication software supporting IMAP4, MAPI, POP3, SMF/MHS, SMTP, or VIM protocols, or future email protocols. The Sender's Client Software 115 may also include an Internet browser if the Sender 105 wishes to send the Email Messages 365 via a webpage.

The Sender's Client Software 115 may forward the Email Message 365 to a Sender's Email Server 120. The Sender's Email Server 120 is typically a computer running server-side email applications, such as MS Exchange Server, Lotus Domino by IBM Corp., Sendmail by Sendmail, Inc., etc. The Sender's Email Server 120 may be maintained by the Sender 105 or a third party. Often for small companies and individual users, the Sender's Email Server 120 is maintained by Internet Service Providers (ISP), Hosting Service Providers (HSP), or Email Service Providers (ESP), such as AOL, Yahoo, Google, Go Daddy, etc.

The Sender's Email Server 120 may then save the Email Message 365 into an Email Storage 350 and form an Email Tickler 355. The Email Tickler 355 is a small message containing information about the location of the Email Message 365 saved into the Email Storage 350. The Email Tickler 355 may be formed, for example, in text or Extensible Markup Language (XML) formats. Typically, the Email Tickler 355 will contain a Uniform Resource Identifier (URI) to the Email Message 365 on a computer network. The URI may refer to FTP (File Transfer Protocol), HTTP (Hypertext Transfer Protocol), or other suitable network protocol for downloading a message from the computer network. The URI may be formed in accordance with the RFC 2396, which is hereby incorporated in its entirety by reference.

The Email Tickler 355 may be formed either in a non-email format or in the email format. If formed in the email format, the Email Tickler 355 must have an additional header field, which indicates the location of the saved Email Message 365 on the computer network. If the Email Tickler 355 is formed in the email format, it may be formed in accordance with the RFC 822, 1123, 2045, and/or 2822, which are hereby incorporated in their entirety by reference.

The Email Tickler 355 may contain a variety of email message attributes. The email message attributes may include: the email message headers, the date and time the message was sent, the email message ID, the email message size, the Recipient's email address, the Recipient's name, the Sender's email address, the Sender's name, a reply-to field, a decryption key, a checksum of the message or its parts, a hash value of the message or its parts, any other value derived from the message or its parts, or any combination thereof.

The Sender's Email Server 120 may then send the Email Tickler 355 to a Recipient's Email Server 140. The Recipient's Email Server 140 may send a Request 360 to the Email Storage 350. The Request 360 may be, for example, an HTTP or an FTP request. In response, the Email Storage 350 will release the Email Message 365 to the Recipient's Email Server 140. The Recipient 125 may then use a Recipient's Client Software 135 to download the Email Message 365 from the Recipient's Email Server 140. The Email Tickler 355 may further contain a pass-code that would guaranty the access to the Email Message 365 only by intended Recipient 125.

If the Email Tickler 355 is formed in email format, the body of the Email Tickler 355, typically, will be empty. Alternatively, the body of the Email Tickler 355 may contain a browser-executable link to a webpage containing a representation of the Email Message 365. This will help to provide a smooth transition from existing email systems and protocols to the proposed system. If Recipient's system does not support handling of the Email Tickler 355, the Recipient 125 will have an option to see the Email Tickler 355 as an email message with a browser-executable link in it. Traditional email messages with a browser-executable link and the absence of the additional header field, which indicates the location of the saved Email Message 365 on the computer network, does not constitute the Email Tickler 355.

The elements of the system of the present invention may be located on various networked computers. Some of the elements may share a single computer, e.g. the functions of the Sender's Email Server 120 and the Email Storage 350 may be performed on a single computer.

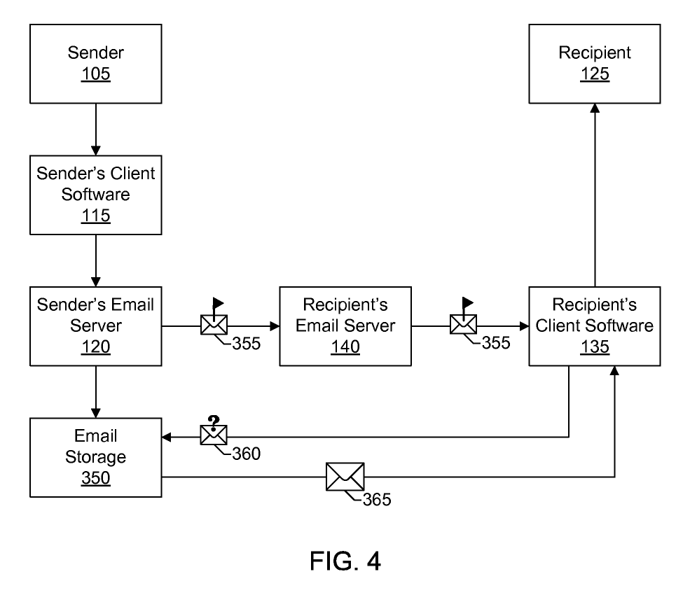

Further, as shown in FIG. 4, the tasks of receiving the Email Tickler 355, sending the Request 360, and downloading the Email Message 365 from the Email Storage 350 may be performed by the Recipient's Client Software 135.

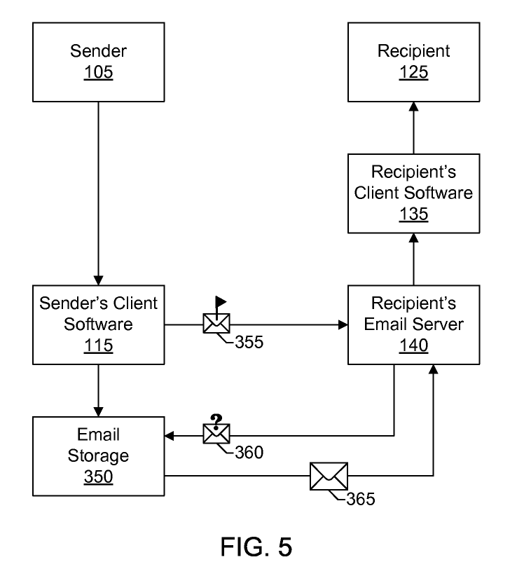

An alternative embodiment of a system of the present invention is shown in FIG. 5. In this embodiment a Sender 105 sends one or more Email Messages 365 to a Recipient 125. The Sender 105 may utilize a Sender's Client Software 115 to form and send the Email Messages 365. The Sender's Client Software 115 may save the Email Message 365 in an Email Storage 350 and form an Email Tickler 355. The Sender's Client Software 115 may send the Email Tickler 355 to a Recipient's Email Server 140. The Recipient's Email Server 140 may send a Request 360 to the Email Storage 350. In response, the Email Storage 350 will release the Email Message 365 to the Recipient's Email Server 140. The Recipient 125 then may use a Recipient's Client Software 135 to download the Email Message 365 from the Recipient's Email Server 140.

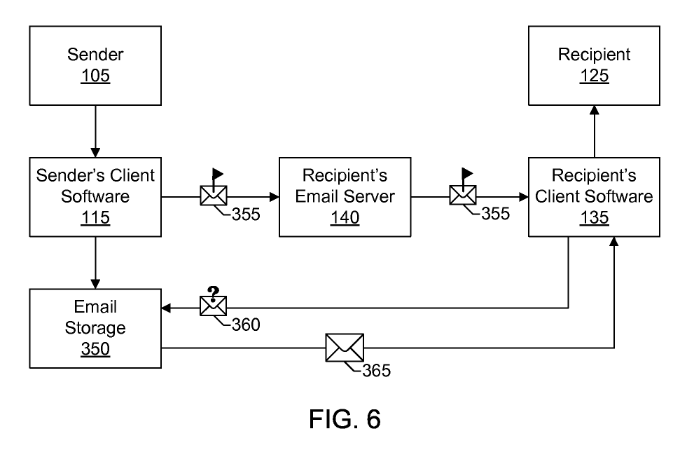

Further, as shown in FIG. 6, the tasks of receiving the Email Tickler 355, sending the Request 360, and downloading the Email Message 365 from the Email Storage 350 may be performed by the Recipient's Client Software 135.

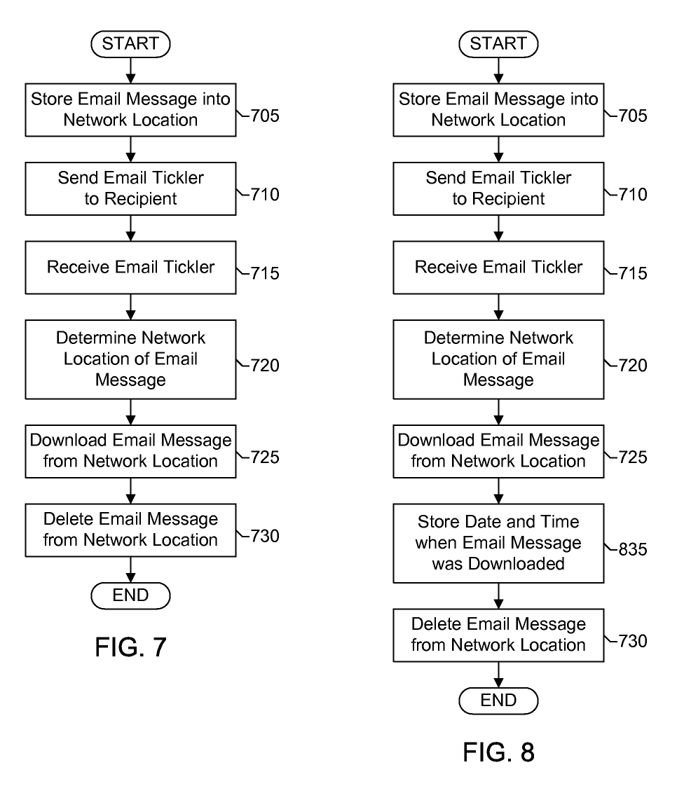

FIG. 7 illustrates an embodiment of a process of the present invention. A Sender's Sending Means may store an Email Message into a Network Location (Step 705). The Sender's Sending Means may send an Email Tickler to a Recipient 125 (Step 710). The Sender's Sending Means may include a Sender's Client Software 115 and/or a Sender's Email Server 120. The Network Location is any storing means suitable for storing email messages on a computer network.

A Recipient's Receiving Means may receive the Email Tickler (Step 715). The Recipient's Receiving Means may determine the Network Location of the Email Message (Step 720). The Network Location may be represented by an URI in the Email Tickler. The Recipient's Receiving Means may download the Email Message from the Network Location (Step 725). The Recipient's Receiving Means may include a Recipient's Client Software 135 and/or Recipient's Email Server 140. After the Email Message has been downloaded from the Network Location, the Sender's Sending Means (or other means that operate the storage on the Network Location) may delete the Email Message from the Network Location (Step 730).

Alternatively, as shown in FIG. 8, when the Email Message has been downloaded from the Network Location, the Sender's Sending Means (or other means that operate the storage on the Network Location) may store the date and time when the Email Message was downloaded from the Network Location (Step 835). Storing date and time may serve as an Email Message Receipt Confirmation and may provide further advantages in auditing the Email Messages on the Network Location.

If the Email Message is going to be deleted from the Network Location (Step 730), the date and time when the Email Message was downloaded from the Network Location may be stored in association with a Message ID.

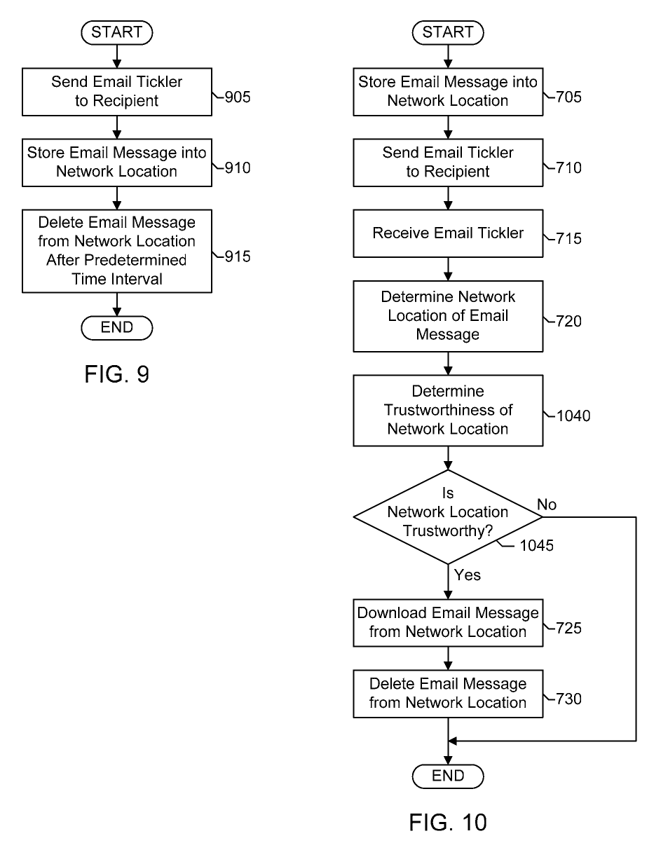

The systems and methods of the present invention may, further, provide for the expiration of the email messages stored on the Network Location. Referring to FIG. 9, a Sender's Sending Means may send an Email Tickler to a Recipient 125 (Step 905) and store an Email Message into a Network Location (Step 910). Then the Email Message may be deleted from the Network Location after a predetermined time interval (Step 915). This will free up the storage resources on the Network Location. The Email Messages that were downloaded and the Email Messages that were never downloaded by a Recipient may have different expiration time intervals.

The present invention allows the Recipient to choose to download the message from a Network Location. A method illustrating this approach is shown in FIG. 10. A Sender's Sending Means may store an Email Message into a Network Location (Step 705). The Sender's Sending Means may send an Email Tickler to a Recipient 125 (Step 710). A Recipient's Receiving Means may receive the Email Tickler (Step 715). The Recipient's Receiving Means may determine the Network Location of the Email Message (Step 720).

A Recipient 125 or the Recipient's Receiving Means may determine the trustworthiness of the Network Location (Step 1040). The trustworthiness of the Network Location may be determined, for example, by verifying a Network Location's IP address against databases of known spam operations, e.g. The Spamhaus Project at www.spamhaus.org. If the Network Location is trustworthy (Step 1045), the Recipient's Receiving Means may download the Email Message from the Network Location (Step 725). Optionally, after the Email Message was downloaded from the Network Location, the Sender's Sending Means (or other means that operate the storage on the Network Location) may delete the Email Message from the Network Location (Step 730).

If it was determined that the Network Location is not trustworthy, the Recipient's Receiving Means may ignore the Email Tickler and may not download the Email Message from the Network Location.

Alternatively, the Recipient's Receiving Means may utilize a variety of techniques to determine if the message should be downloaded. Such techniques may include black list and/or white list filters, checking the size of the Email Message and refusing it if it is too large, or any other currently known or future techniques.

After the Email Message has been downloaded, the Email Tickler may be deleted. Optionally, if it was determined that the Network Location is not trustworthy or if the trustworthiness cannot be determined, the Email Tickler may be shown to a Recipient for manual determination if the Email Message should be downloaded.

If the Email Message was downloaded, the means operating the storage at the Network Location may record the date and time when the message was downloaded, may flag the Email Message as downloaded, or use any other approach to mark the Email Message as downloaded.

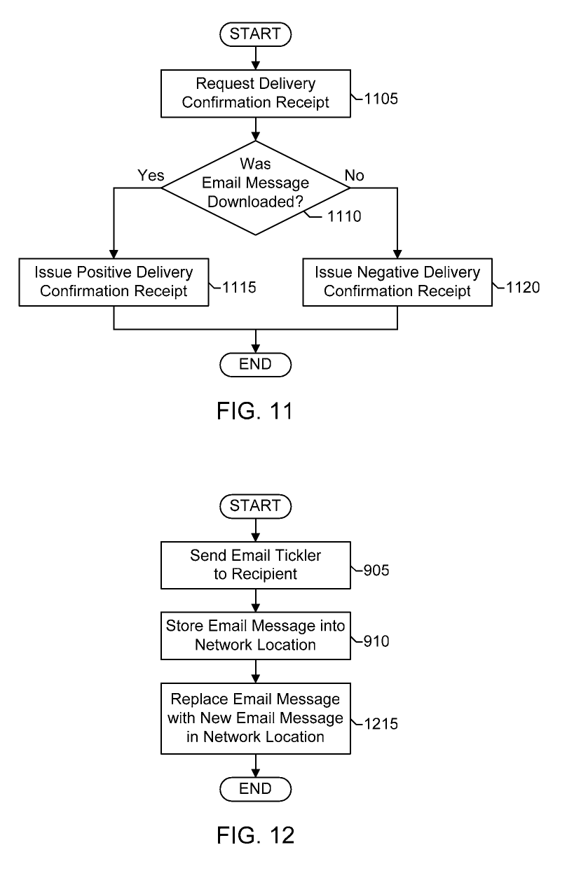

FIG. 11 demonstrates a sample method of obtaining a delivery confirmation receipt from the means operating the storage at the Network Location. A Requesting Means may request a delivery confirmation receipt for one or more Email Messages from a Storing Means (Step 1105). The Requesting Means may include the Sender 105, the Sender's Sending Means, the Recipient 125, the Recipient's Receiving Means, etc. The Storing Means is the means operating the storage at the Network Location. If the Email Message was downloaded (Step 1110), the Storing Means will issue a positive delivery confirmation receipt (Step 1115). If the Email Message was not downloaded, the Storing Means will issue a negative delivery confirmation receipt (Step 1120).

The systems and methods of the present invention may further provide for a replacement of the Email Message by a Sender. The need for the replacement may take place if the Sender realized that he/she made an error in the Email Message.

Referring to FIG. 12, a Sender's Sending Means may send an Email Tickler to a Recipient 125 (Step 905) and store an Email Message into a Network Location (Step 910). The Sender's Sending Means may then replace the Email Message with a New Email Message in the Network Location (Step 1215).

Alternatively, the Email Message in the Network Location may be deleted. The deletion of the Email Message may be necessary if the Email Message, for example, was addressed to an unintended Recipient. This feature is also known as a message recall.

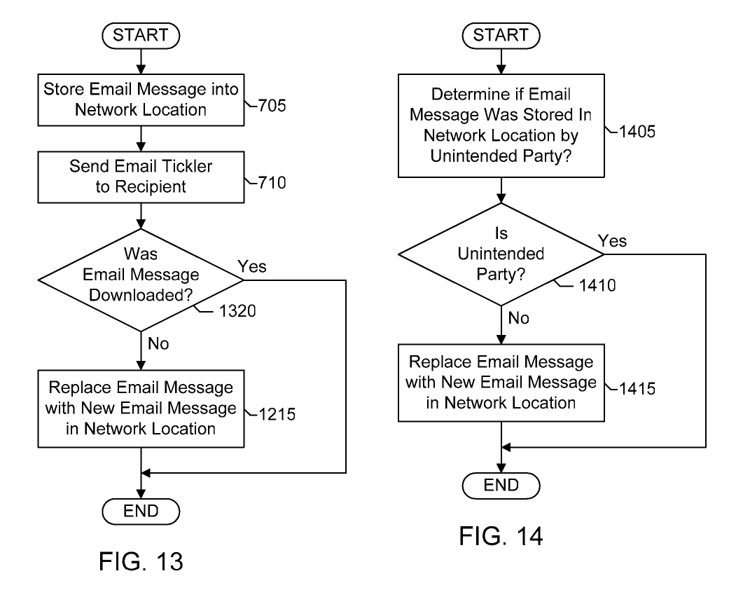

In the instances when the Recipient 125 has already downloaded the Email Message, the message replacement and deletion may have no effect and the Email Message may be left intact. Referring to FIG. 13, a Sender's Sending Means may store an Email Message into a Network Location (Step 705). The Sender's Sending Means may send an Email Tickler to a Recipient 125 (Step 710). If a Sender 105 issues a message recall command, the Sender's Sending Means may determine if the Email Message was already downloaded (Step 1320). If the Email Message was not yet downloaded, the Sender's Sending Means may delete the Email Message or replace it with a New Email Message in the Network Location (Step 1215).

One of the common techniques utilized by spammers is compromising third party computers by installing viruses, trojans, spyware, etc. and obtaining rights to perform operations reserved for the lawful owners. After the computer is compromised, spammers may send literally millions of emails in a short period of time using the “zombie” computer. After that the spammers may delete all traces of their activity from the computer. The proposed systems and methods may prevent or reduce the exploitation of compromised computers. Because the Email Message must remain on the computer at least until the Recipient's Receiving Means has downloaded the message, the computer administrator may have a chance to remove the Email Messages originated by the spammers.

FIG. 14 illustrates a sample method for cleaning up compromised computers. A computer administrator, a Sender's Sending Means, or another entity may determine if an Email Message was stored in a Network Location by an Unintended Party (Step 1405). If so (Step 1410), then the Email Message may be replaced or deleted (Step 1415).

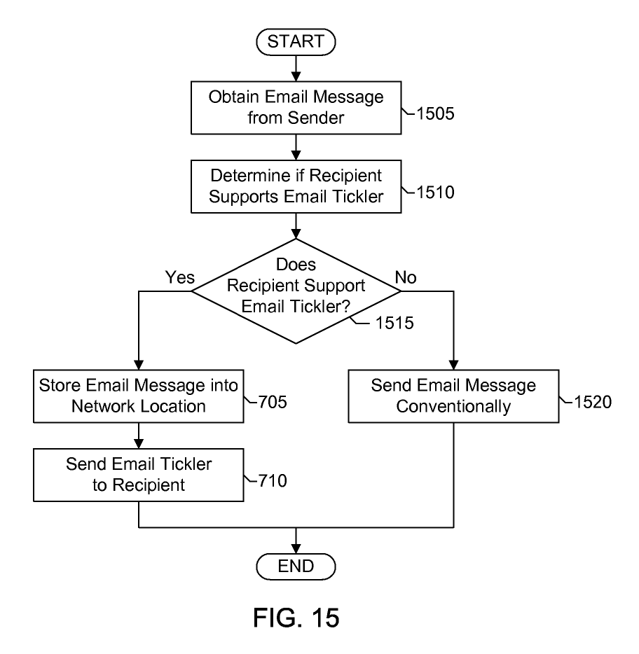

To ensure a smooth transition from conventional email systems to the email systems utilizing the Email Tickler approach, the email systems may be designed so that it is possible to determine if the receiving system supports the Email Tickler approach. Referring to FIG. 15, a Sender's Sending Means may obtain an Email Message from a Sender 105 (Step 1505). The Sender's Sending Means may determine if a Recipient's Receiving Means supports an Email Tickler approach (Step 1510). This may be determined, for example, by contacting a Recipient's Email Server 140 and exchanging data with it to determine what email server-side software it is running and the version of that software.

If the Recipient's Receiving Means supports the Email Tickler approach (Step 1515), then the Sender's Sending Means may store the Email Message into a Network Location (Step 705). The Sender's Sending Means may then send an Email Tickler to a Recipient 125 (Step 710). If the Recipient's Receiving Means does not support the Email Tickler approach (Step 1515), then the Sender's Sending Means may send the Email Message conventionally (Step 1520).

The systems and methods or the present invention may be further enhanced by utilizing Public Key Infrastructure (PKI) to digitally sign and/or encrypt Email Messages and/or Email Ticklers.

The systems and methods of the present invention may further be utilized for email message forwarding. If an original Email Message was sent using an Email Tickler and the Message still remains in a Network Location, a forwarded message may include the Email Tickler of the original message. This would allow a Recipient of the forwarded message to download the original message from the Network Location. Similarly this may apply to Email Message replies.

U.S. patent application Ser. No. 10,418,006, entitled “A Mail Server Probability Spam Filter”, filed on Apr. 17, 2003 is hereby incorporated in its entirety by reference.

U.S. patent application Ser. No. 10,977,373, entitled “Tracking Domain Name Related Reputation”, filed on Oct. 29, 2004 is hereby incorporated in its entirety by reference.

U.S. patent application Ser. No. 11,011,630, entitled “Email Filtering System and Method”, filed on Dec. 14, 2004 is hereby incorporated in its entirety by reference.

U.S. patent application Ser. No. 11,030,612, entitled “Electronic Mail System and Method”, filed Jan. 6, 2005 is hereby incorporated in its entirety by reference.

Other embodiments and uses of this invention will be apparent to those having ordinary skill in the art upon consideration of the specification and practice of the invention disclosed herein. The specification and examples given should be considered exemplary only, and it is contemplated that the appended claims will cover any other such embodiments or modifications as fall within the true scope of the invention.

The Abstract accompanying this specification is provided to enable the United States Patent and Trademark Office and the public generally to determine quickly from a cursory inspection the nature and gist of the technical disclosure and is in no way intended for defining, determining, or limiting the present invention or any of its embodiments.

The invention claimed is:

1. An electronic mail system, comprising:
a) a Sending Means, having an ability to send an email tickler, wherein said email tickler contains a network location of an email message, and
b) a Storing Means, wherein said Sending Means having an ability to store said email message for said email tickler in said Storing Means.

2. The system of claim 1, wherein said Sending Means, at least in part, comprises a Sender's Client Software.

3. The system of claim 1, wherein said Sending Means, at least in part, comprises a Sender's Mail Server.

4. The system of claim 1, further comprising:
c) a Receiving Means, having an ability to receive said email tickler and download said email message from said network location.

5. The system of claim 4, wherein said Receiving Means, at least in part, comprises a Recipient's Client Software.

6. The system of claim 4, wherein said Receiving Means, at least in part, comprises a Recipient's Mail Server.

7. The system of claim 4, further comprising:
d) a Selecting Means, having an ability to determine if said email message should be downloaded based on said email tickler.

8. The system of claim 4, wherein said email message is deleted from said Storing Means after it was downloaded by said Receiving Means.

9. The system of claim 4, wherein said Storing Means stores a date and time when said email message was downloaded by said Receiving Means.

10. The system of claim 4, wherein said download of said email message serves as a delivery confirmation receipt.

11. The system of claim 1, wherein said email tickler is formed according to an email message standard, having an additional field in the message headers containing said network location of said email message.

12. The system of claim 11, wherein a message body of said email tickler is empty.

13. The system of claim 11, wherein a message body of said email tickler does not contain a browser-executable link.

14. The system of claim 11, wherein a message body of said email tickler does not contain an embedded image.

15. The system of claim 11, wherein a message body of said email tickler does not contain a linked image.

16. The system of claim 11, wherein a message body of said email tickler does not contain a frame linked to a webpage.

17. The system of claim 11, wherein said email tickler does not contain a shared attachment.

18. The system of claim 11, wherein said email message standard is the RFC 822.

19. The system of claim 11, wherein said email message standard is the RFC 1123.

20. The system of claim 11, wherein said email message standard is the RFC 2822.

21. The system of claim 11, wherein a message body of said email tickler contains a browser-executable link for supporting prior art email systems.

22. The system of claim 11, wherein a message body of said email tickler contains a frame linked to a webpage for supporting prior art email systems.

23. The system of claim 1, wherein said network location of said email message is represented by a Uniform Resource Identifier (URI).

24. The system of claim 1, wherein said email tickler is not formed according to an email message standard.

25. The system of claim 1, wherein said email message is deleted from said Storing Means after a predetermined time interval.

26. An electronic mail system, comprising:
a) a Storing Means, having an ability to store an email message associated with an email tickler, wherein said email tickler contains a network location of said email message, and
b) a Receiving Means, having an ability to receive said email tickler and download said email message from said network location.

27. An electronic mail system, comprising:
a) a Sender's Client Software, having an ability to send an email tickler, wherein said email tickler contains a network location of an email message,
b) an Email Storage, wherein said Sender's Client Software having an ability to store said email message for said email tickler in said Email Storage, and
c) a Recipient's Client Software, having an ability to receive said email tickler and download said email message from said Email Storage.

28. An electronic mail system, comprising:
a) a Sender's Mail Server, having an ability to send an email tickler, wherein said email tickler contains a network location of an email message,
b) an Email Storage, wherein said Sender's Mail Server having an ability to store said email message for said email tickler in said Email Storage, and
c) a Recipient's Mail Server, having an ability to receive said email tickler and download said email message from said Email Storage.
